(19) United States
(12) Patent Application Publication
(10) Pub. No.: US 2026/0295755 A1
(43) Pub. Date: Oct. 1, 2026

(54) Machine Tool for Workpiece Machining, Hydraulic Device, Hydraulic System and Method for Workpiece Machining

(71) Applicants: DMG MORI Pfronten GmbH, Pfronten (DE); ifm electronic GmbH, Essen (DE)

(72) Inventors: Rolf KETTEMER, Marktoberdorf (DE); Wolfgang DIETENHAUSER, Waltenhofen (DE); Florian BOOS, Pfronten (DE); Peter BUHL, Kressbronn (DE); Piotr GRACA, Izbicko (PL)

(21) Appl. No.: 19/477,078

(22) PCT Filed: Apr. 22, 2024
(86) PCT No.: PCT/EP2024/060935

§ 371 Date: Oct. 20, 2025

(30) Foreign Application Priority Data
Apr. 25, 2023 (DE) 10 2023 110 560.4

(51) Int. Cl. B23Q 11/10; G01F 1/00

(52) U.S. Cl. CPC B23Q 11/1015; B23Q 11/1038; G01F 1/00

(57) ABSTRACT

A machine tool including a working space, at least one fluid consumer, via which a machining fluid for workpiece machining can be supplied to, a hydraulic device, configured to supply the at least one fluid consumer with the machining fluid, and a control device for controlling the machine tool. The hydraulic device includes a pump for conveying the machining fluid, an inflow, via which machining fluid conveyed by the pump is conducted to the at least one fluid consumer, and a flow measuring device, which is assigned to the inflow and includes at least one first measuring unit and one second measuring unit, which are each configured to detect a throughflow rate of the machining fluid in the inflow. The control device controls the machine tool as a function of a first actual value detected by the first measuring unit, and/or a second actual value detected by the second measuring unit.

### TECHNICAL FIELD

The present invention relates to a machine tool for workpiece machining, a hydraulic device for use on such a machine tool, a hydraulic system and a method for workpiece machining.

### BACKGROUND OF THE INVENTION

In the field of workpiece machining, machining fluids are usually used, in particular cooling lubricants (CL for short), via which the workpiece machining is to be improved with regard to wear of the tool and machining quality. The CLs are generally oil-water emulsions which are supplied to a machining region, that is to say a region in which a tool removes material from a workpiece by machining.

The use of the machining fluid reduces the friction between workpiece and tool and dissipates the heat which is inevitably produced during the workpiece machining from the machining region.

The machining fluid therefore serves for cooling the tool or the workpiece and for reducing the wear of the tool. Furthermore, the machining fluid can be used in some machining processes for removing the produced chips by rinsing from the machining region. In addition, the machining fluid can have corrosion-inhibiting properties, as a result of which workpiece and/or workpiece are protected against corrosion during or after the workpiece machining.

The above effects improve the machining quality and therefore the dimensional accuracy of the workpiece, for example the surface quality, which leads to high-quality manufactured workpieces.

In the prior art, it is customary to provide the machining fluid on the machine tool by means of a speed-controlled pump. Since no risk can be assumed during the supply during the workpiece machining, the provision by the pump takes place with a constantly predefined and comparatively high supply pressure of approximately 40 to 100 bar, in order in any case to prevent an undersupply of the machining region during the workpiece machining, as a result of which, for example, the tool used becomes unusable.

The general provision of a constant supply pressure during the complete workpiece machining in such a high pressure range is inevitably associated with a high energy requirement of the pump. Depending on the configuration of the component supplying the machining fluid, in particular depending on the fluid-mechanical properties thereof, this can lead to a high power loss in that the pump provides a higher supply pressure than is actually required.

As a result, the service life of the pump and other hydraulic components for the supply with the machining fluid is reduced, as a result of which maintenance effort and costs increase. Furthermore, the energy consumption for the supply with the machining fluid is sometimes unnecessarily high, which in turn leads to high energy costs, which are not insignificant precisely in the field of mass production.

### SUMMARY

The present invention is therefore based on the object of overcoming the problems known in the prior art and of providing a possibility for workpiece machining using a machining fluid which is improved in relation to the prior art and with which, in particular, an energy consumption during workpiece machining and a loading of hydraulic components are reduced.

In order to achieve this object, a machine tool for workpiece machining according to claim 1, a hydraulic device according to claim 20, a hydraulic system according to claim 21 and a method for workpiece machining according to claim 22 are provided.

The respective dependent claims relate here to preferred embodiments which can be provided in each case by themselves or in combination.

According to a first aspect of the invention, a machine tool for workpiece machining using a machining fluid, in particular a cooling lubricant, is provided. The machine tool comprises a working space, in which the workpiece machining is carried out, at least one fluid consumer, via which a machining fluid for workpiece machining can be supplied to the working space, a hydraulic device, which is configured to supply the at least one fluid consumer with the machining fluid, and a control device for controlling the machine tool. The hydraulic device comprises a pump for conveying the machining fluid, an inflow, via which machining fluid conveyed by the pump is conducted to the at least one fluid consumer, and a flow measuring device, which is assigned to the inflow and comprises at least one first measuring unit and one second measuring unit, which are each configured to detect a throughflow rate of the machining fluid in the inflow, in particular a volume flow of the machining fluid. In this case, the control device is configured to control the machine tool, in particular the hydraulic device as part of the machine tool, as a function of a first actual value, which is detected by the first measuring unit, and/or a second actual value, which is detected by the second measuring unit, of the throughflow rate, in particular the volume flow of the machining fluid in the inflow.

During the workpiece machining, the machining fluid flows through the fluid consumer into the working space of the machine tool and is supplied to the machining region in order to support the workpiece machining there as described at the outset.

In this case, the fluid consumer can be understood to mean any component of the machine tool via which the machining fluid for workpiece machining can be supplied to the working space. In this case, the discharge into the working space can be carried out directly or via nozzles, nebulizers or other components which are attached to the fluid consumer and permit a throughflow of the machining fluid and thus function as supply points.

A throughflow rate is intended to be understood to mean any variable via which a quantity of the machining fluid flowing through a respective component, for example the inflow or the fluid consumer, over a specific period of time is specified. This can be, in a non-exhaustive manner, a volume flow, a mass flow or else a flow velocity from which, for example, the mass flow or the volume flow can be calculated with knowledge of density and flow cross section. It goes without saying that any reference to a throughflow rate can be replaced in this description by a reference to one of the preceding variables.

Preferably, a tool having inner fluid ducts is attached to the fluid consumer, via which tool the machining fluid is discharged into the working space. As a result, not only is the machining fluid supplied directly via the tool to the machining region, but the tool is additionally cooled by the machining fluid flowing into the interior thereof. As a result, the concept of internal CL supply known in the prior art is implemented.

Ultimately, the quantity of the supplied machining fluid is decisive for workpiece machining and not the supply pressure present at the fluid consumer.

Depending on the fluid-mechanical properties of a supply point at the fluid consumer, for example the geometric dimensions of an opening or of a duct through which the machining fluid passes into the working space, the supply pressure does not have a significant influence or only a slight influence on the throughflow rate or on the volume flow above a certain value, such that an increase in the supply pressure primarily increases only a power loss of the hydraulic device without significantly increasing the supply of the machining fluid in the process. As a result, the components of the hydraulic device would be unnecessarily stressed and also unnecessarily high energy costs would be caused.

This is the case in the prior art in which, with the aid of pressure measuring units of the hydraulic device, the supply pressure present at the fluid consumer is generally kept at the 40 to 100 bar mentioned at the outset, which corresponds to a pressure controller. In particular in view of the multiplicity of usable supply points and the respectively different fluid-mechanical properties thereof, the disadvantages associated therewith can be of different severity.

The present invention now breaks with this disadvantageous concept of pressure controller during the supply of the machining fluid and provides in particular the necessary hardware on the part of the machine tool for implementing a reliable throughflow rate controller or a volume flow controller if the throughflow rate to be controlled is a volume flow (instead of the customary pressure controller). This makes it possible in particular to use a multiplicity of fluid-mechanically different supply points while always maintaining optimum operating conditions of the hydraulic device.

In order to implement a throughflow rate controller or regulation, the throughflow rate of the machining fluid in the inflow has to be able to be determined reliably and as accurately as possible. This is possible only with difficulty on account of the multiplicity of usable supply points and the throughflow rates or volume flows in the inflow which are of great different severity as a result, that is to say a comparatively large range of values to be covered.

In this case, the hydraulic device can be set up to provide throughflow rates specified as volume flows in the inflow during the workpiece machining in a range of 0.001 liters per minute (l/min) to 80 l/min or in a range of 0.01 to 50 l/min, which in particular correspond to the said range of values to be covered.

The inventors have now found out that the accuracy required for implementing a robust throughflow rate controller or regulation can be achieved over the said large range of values through the use of the above-described throughflow measuring device which comprises at least two measuring units which are independent of one another. The two measuring units complement one another in order thus to cover the said large range of values and to provide the measurement accuracy required for the throughflow rate controller or regulation both for small and for large throughflow rates.

As a result, it is possible, for example, to detect throughflow rates specified as volume flows in a range of a few hundred milliliters per minute up to over 30 l/min reliably and accurately.

The former is the case, for example, in the case of internal CL supply via drills with a diameter of a few millimeters, whereas the latter is a customary value in the case of internal CL supply via milling heads in the case of large-area workpiece machining.

As a result of the two measurements taking place independently, a reliable statement can therefore always be made about the current throughflow rate in the inflow, to be precise over the entire range of values of possible throughflow rates in the inflow which is of large severity in the context of the invention, which is the basis for a reliable throughflow rate controller.

The described construction of the machine tool or of the hydraulic device therefore permits a reliable throughflow rate controller or volume flow controller during the supply of the fluid consumer, to be precise independently of fluid-mechanical properties of the actual supply point. An optimum throughflow rate or an optimum volume flow can thus always be provided.

The present invention therefore makes possible a throughflow rate controller or volume flow controller with which disadvantageous operating states with an “excessively high” pressure for a multiplicity of supply points of different fluid-mechanical configuration can be successfully avoided. As a result, a loading of the hydraulic device and a power loss occurring within the latter can be considerably reduced, which in turn reduces the energy costs during the operation of the machine tool and increases the service life of the hydraulic device itself.

Particularly with regard to the concept of internal CL supply, the machine tool according to the invention or the hydraulic device thereof for throughflow rate controller creates the possibility of always setting the optimum throughflow rate for the respective tool having inner fluid ducts, in order thus to achieve the optimum cooling and lubrication with the lowest possible power loss of the hydraulic device.

The conventional pressure controller is very imprecise in comparison with this, and an optimum pressure for a respective process cannot be determined or can be determined only with difficulty if at all. In addition, such values cannot be transferred to other machine tools even in the case of the same tool or the same process, since the pressure present at the fluid consumer varies here on account of different pipings and the like.

In contrast to this, the invention affords the advantage that this is largely independent of specific properties of individual machine tools, such that optimum values determined on a machine tool for the throughflow rate of individual tools having internal CL supply can also be transferred without problems to other machine tools and lead substantially to the same results there.

A further negative effect in the case of the conventional pressure controller with “excessively high” pressure is the high atomization of the machining fluid during introduction into the working space. In particular during the use of the mist extraction device which is usually used in this region for discharging the atomized machining fluid, the high atomization causes a high consumption of the machining fluid and high energy costs for operating the mist extraction device.

In contrast to this, the possibility according to the invention affords the advantage that a controlled quantity of machining fluid is introduced, that is to say not “too much”, such that an oversupply, which leads, inter alia, to an unnecessarily high atomization, can be successfully avoided. The control device is preferably configured to control the hydraulic device and in particular the pump thereof as a function of the detected first and/or the detected second actual value, preferably by setting an operating parameter of the pump determining the delivery capacity.

The machine tool is preferably a numerically controlled machine tool, wherein the control device is configured to control various actuators of the machine tool. In addition to drives of a machining device, for example a working spindle, said actuators can also include drives of a workpiece receptacle, for example a machine table.

The machine tool can optionally also comprise two control devices; one for the hydraulic device and one for other actuators which do not belong to the hydraulic device. These two control devices are preferably coupled to one another in this case.

The throughflow measuring device can preferably comprise further measuring units for the throughflow rate in order thus to increase the measurement accuracy in the range of values to be covered even further.

The throughflow measuring device preferably comprises an evaluation unit which is configured to select, from the two detected actual values, a reference value which is used for the control of the machine tool. Alternatively, the evaluation unit can be configured to determine, from the two detected actual values, a resulting throughflow rate value, for example by weighted averaging of the detected actual values, wherein the weighting factors themselves are preferably dependent on one or both detected actual values. Said resulting throughflow rate value can be used in this case for the control of the machine tool.

As a result, differences between the two measuring units, in particular with regard to their measurement ranges and measurement deviations, can be better taken into account in order thus to improve the accuracy of the control even further.

In a preferred embodiment, the throughflow measuring device is a volume flow measuring device, such that at least the throughflow rate in the inflow is specified via a volume flow.

In a preferred embodiment, the first measuring unit and the second measuring unit are arranged in series with respect to a flow direction of the machining fluid in the inflow.

As a result, the actual values are detected one behind the other, such that the detected actual values relate to the same fluid flow.

In a preferred embodiment, a measuring range of the first measuring unit differs from a measuring range of the second measuring unit, in particular none of the two measuring ranges is a subset of the respectively other measuring range.

As a result, the two measuring units complement one another in order to cover the large range of values of the possible throughflow rates as completely as possible.

The measuring ranges of the measuring units may be a nominal but also a technical measuring range, in which measured values of the throughflow rate to be controlled that can be used accurately and thus also for the control can be detected.

In this case, the measuring range describes a range of values of the variable to be measured, here the throughflow rate, for example via the volume flow, in which the measurement deviations remain within fixed limits. Preferably, with respect to a volume flow, the absolute maximum measurement deviation of the first measuring unit in its measuring range is less than or equal to 3 l/min, further preferably less than or equal to 1.5 l/min, further preferably less than or equal to 0.75 l/min and particularly preferably less than or equal to 0.1 l/min. Further preferably, the absolute maximum measurement deviation of the second measuring unit in its measuring range is less than or equal to 8 l/min, further preferably less than or equal to 5 l/min, further preferably less than or equal to 2.5 l/min and particularly preferably less than or equal to 1 l/min.

In a preferred embodiment, the measuring range of the first measuring unit and the measuring range of the second measuring unit overlap in an overlap region.

As a result, the two measuring ranges can be combined particularly well without accepting excessively large measurement deviations in the region of the transition from one measuring range to the other.

In a preferred embodiment, the measuring range of the first measuring unit is a range of 0 to 30 l/min, preferably a range of 0.01 to 15 l/min, and/or the measuring range of the second measuring unit is a range of 1 to 80 l/min, preferably a range of 1 to 50 l/min.

In a preferred embodiment, the measuring ranges of the first and second measuring units and a minimum volumetric flow rate of the pump are matched to one another in such a way that the minimum volumetric flow rate lies in the overlap region.

The minimum volumetric flow rate denotes the lowest volumetric flow rate which the pump can provide during proper operation. If an attempt is made to set a lower volumetric flow rate, disadvantageous operating states generally occur, for example with undesired overheating or resonant oscillations of the mechanical components, which does not exactly correspond to proper operation.

In a preferred embodiment, a volumetric flow rate operating range of the pump is a subset of a combining set of the measuring ranges of the first and second measuring units.

As a result, the complete range of volumetric flow rates which can be implemented by the pump lies within the resulting measuring range spanned by the two measuring units.

In this case, the volumetric flow rate operating range describes the possible volumetric flow rates which the pump can provide on account of its factory specifications. The lower limit of the volumetric flow rate operating range usually corresponds to the minimum volumetric flow rate; however, this does not have to be the case.

In a preferred embodiment, the volumetric flow rate operating range of the pump is a range of 0.1 to 80 l/min, preferably of 1 to 50 l/min and particularly preferably of 5 to 40 l/min.

Preferably, the pump can build up a pressure in the inflow of up to 100 bar, preferably of up to 80 bar and particularly preferably of up to 50 bar.

As a result of the volumetric flow rate controller, it is no longer necessary to provide as high a supply pressure as possible in order to provide a certain minimum volumetric flow rate in this way, such that the pump can be dimensioned smaller per se.

In a specific embodiment, in which the throughflow measurement or the volumetric flow rate measurement has proven to be particularly accurate, the volumetric flow rate operating range of the pump extends from 5 to 36 l/min, the first measuring range extends from 0.01 to 15 l/min with an absolute maximum measurement deviation of 0.75 l/min and the second measuring range extends from 1 to 50 l/min with an absolute maximum measurement deviation of 2.5 l/min.

In a preferred embodiment, the machine tool furthermore comprises a setpoint value transmitter, via which a setpoint value of a throughflow rate present at the at least one fluid consumer, in particular of a volumetric flow rate of the machining fluid, is provided.

In this case, the control device is preferably configured to control the hydraulic device as a function of the setpoint value provided by the setpoint value transmitter and the detected first actual value and/or the detected second actual value, or as a function of the determined resulting throughflow rate value, in particular in order to control the throughflow rate present at the at least one fluid consumer.

In this case, the setpoint value transmitter can be embodied as a separate component of the machine tool, or as part of the control device. Alternatively, the setpoint value transmitter can also be provided externally, for example in an external data management system, which is connected to the machine tool via a data interface.

As a result, the hydraulic device can be individually matched to any desired tool, in which the associated tool parameters are read out and used for the control. An optimum throughflow rate, in particular an optimum volumetric flow rate, which is determined and stored for a specific tool in advance for the tool, can thus be used particularly advantageously for the control.

In a preferred embodiment, the control device is configured to set an operating parameter of the pump of the hydraulic device determining the delivery capacity, in particular a delivery quantity or a rotational speed of the pump, as a function of the provided setpoint value and the detected first actual value and/or the detected second actual value, or as a function of the determined resulting throughflow rate value.

In a preferred embodiment, the hydraulic device furthermore comprises a bypass device arranged between the inflow and the pump.

As a result, subsets of the machining fluid conveyed by the pump can be branched off (backflow) before entry into the inflow, in order thus also to be able to provide throughflow rates or volumetric flow rates in the inflow which lie below the minimum volumetric flow rate of the pump. The return flow flowing through the bypass device flows here, for example, back into a fluid tank for the machining fluid.

In a preferred embodiment, the bypass device comprises at least one throughflow regulating means, via which a throughflow of a return flow of the machining fluid flowing through the bypass device can be regulated.

Such regulating means can regulate the throughflow, for example, by changing a flow resistance through the bypass device, for example in the form of a throttle means or a controllable bypass valve which can be controlled by the control device.

Instead of a controllable bypass valve, it is alternatively or additionally also possible to use a bypass pump which can be controlled by the control device, in particular by setting an operating parameter of the bypass pump determining the delivery capacity.

The control device is preferably configured to set an operating parameter of the throughflow regulating means determining the return flow as a function of the detected first and/or the detected second actual value, or as a function of the determined resulting throughflow rate value, and/or the provided setpoint value, in particular in order to control the throughflow rate present at the at least one fluid consumer.

In this way, the controller is supplemented by an additional adjusting screw, with which controllable throughflow rates or volumetric flow rates in the inflow below the minimum volumetric flow rate are also made possible. In this case, the control of the bypass valve preferably comprises setting a degree of opening of the bypass valve or setting a flow resistance of the bypass valve.

In a preferred embodiment, the bypass device comprises a third measuring unit, which is configured to detect a throughflow rate, in particular a volumetric flow rate, of the return flow of the machining fluid flowing through the bypass device.

In this case, the control device is preferably configured to control the hydraulic device additionally as a function of an actual value, which is detected by the third measuring unit, of the throughflow rate of the return flow.

In this case, the control device is in particular configured to set an operating parameter of the pump determining the delivery capacity and/or an operating parameter of the throughflow regulating means of the bypass device determining the return flow additionally as a function of the detected actual value of the throughflow rate of the return flow.

In this way, information about the return flow in the bypass device is also available to the controller, which information can be taken into account in the course of the control.

Preferably, the measuring range of the third measuring unit is a range of 0 to 30 l/min, preferably a range of 0.01 to 15 l/min and particularly preferably 0.01 to 10 l/min. In this case, the absolute maximum measurement deviation of the third measuring unit in its measuring range is preferably less than or equal to 3 l/min, further preferably less than or equal to 1.5 l/min, further preferably less than or equal to 0.75 l/min and particularly preferably less than or equal to 0.1 l/min.

In a preferred embodiment, the at least one fluid consumer is a tool interface for receiving a tool, which tool interface comprises at least one inner fluid duct. In this case, the tool interface is configured to introduce the machining fluid conducted thereto into the tool received in the tool interface or into the at least one fluid duct thereof and to supply the machining fluid to the working space via said fluid duct. This corresponds to the above-described concept of internal CL supply, by which the machining fluid is discharged particularly close to the machining region and additionally cools the tool from the inside.

In this case, the tool interface can be designed for receiving or for holding one or more different tool types, thus, for example, for milling and/or drilling tools, turning tools or grinding tools with internal CL supply.

Alternatively, the at least one fluid consumer can also be a tool holder interface for receiving a tool holder, in which a tool can in turn be received. In this case, the tool holder comprises at least one inner fluid duct, wherein the tool holder interface is configured to introduce the machining fluid conducted thereto into the tool holder or into the at least one fluid duct thereof and to supply the machining fluid to the working space via said fluid duct. In this way, the supply takes place via the tool holder if a tool is used for the machining, which tool itself does not have any fluid ducts.

In a preferred embodiment, the tool interface is designed as a working spindle, via which a received tool can be rotationally driven.

In a preferred embodiment, the setpoint value transmitter is configured to set or define the setpoint value for the throughflow rate present at the fluid consumer or at the tool interface as a function of the tool received therein, in particular as a function of a tool parameter. Preferably, this tool parameter is taken from a tool database and can correspond to a nominal, tool-specific setpoint throughflow rate or a setpoint volume flow. Preferably, in this case, this tool parameter is taken from a pump characteristic curve, stored in the tool database, of the received tool.

As a result, the control can take place on the basis of the throughflow rate or volumetric flow rate determined in advance for a specific tool as optimum. In this case, optimum can be understood to mean an operating state with a minimum of a power loss at the tool while maintaining a minimum quantity of supplied machining fluid. In this case, said minimum quantity can likewise be tool-specific and predetermined.

In a preferred embodiment, the setpoint value transmitter is configured to define the setpoint value additionally or alternatively as a function of at least one machining parameter, which is present at the control device, of the workpiece machining.

As a result, a throughflow rate control adapted to a respective machining step can be implemented, in which the quantity of supplied machining fluid is oriented to the machining, in order to prevent an undersupply but also an oversupply.

The machining parameter is preferably a cutting speed of the tool, a feed speed of the tool or a penetration depth of the tool into the workpiece to be machined.

In a preferred embodiment, the control device is furthermore designed for process monitoring of workpiece machining in the working space and in this context is configured to adapt at least one machining parameter of the workpiece machining as a function of the detected first and/or the detected second actual value, or as a function of the determined resulting throughflow rate value.

The adaptable machining parameters are preferably a machining speed of the tool and/or of the workpiece to be machined, which machining speeds can be, for example, a cutting speed of the tool relative to the workpiece or a feed speed of the tool relative to the workpiece or a cutting force or contact force between workpiece and tool.

The actual values detected by the measuring units provide information about the quantity of machining fluid supplied during workpiece machining, which can be used as a starting point for the detection of a disadvantageous or even abnormal operating state. The actual values can thus provide information about an excessively rapid feed or an excessively low cutting speed. In this case, it is possible to consider, inter alia, tool damage (since this can impede the supply of machining fluid) or inadequate removal of material chips (since these can block the supply of machining fluid) to be abnormal, which both leads to poorer machining quality than “normal”.

In a preferred embodiment, the control device is furthermore configured in the course of the process monitoring to instruct a machine stop of the machine tool if the detected first actual value lies outside a predetermined first setpoint range and/or the detected second actual value lies outside a second predetermined setpoint range.

As a result, financially costly damage to the tool and/or workpiece under certain circumstances can be prevented before this is caused.

The setpoint ranges are preferably determined as a function of the fixed setpoint value, in particular on the basis of a maximum permissible relative deviation, for example of ±75%, or ±50%, or ±25%. Alternatively, the setpoint ranges can also be defined by explicit limit values.

An effective value which is used in the course of the above-described process monitoring can preferably also be determined from the two actual values.

The hydraulic device preferably comprises a temperature measuring unit, which is assigned to the inflow, for detecting a temperature of the machining fluid and/or a pressure measuring unit, which is assigned to the inflow, for detecting a pressure of the machining fluid. These are coupled to the control device, wherein the control of the machine tool is optionally carried out additionally as a function of the values detected by said measuring units in order thus to improve the control of the throughflow rate further or to improve the process monitoring, in particular the detection of abnormal operating states.

According to a second aspect of the invention, a hydraulic device of a machine tool according to the first aspect or a preferred embodiment of the machine tool is provided.

In this way, an existing machine tool can be supplemented by the hydraulic device in order thus to arrive at the machine tool according to the invention without having to provide a completely new machine tool.

According to a third aspect of the invention, a hydraulic system for use on a machine tool is provided, which comprises a hydraulic device, which is configured to supply at least one fluid consumer of the machine tool with a machining fluid for workpiece machining, and a control device. The hydraulic device in turn comprises a pump for conveying the machining fluid, an inflow, via which machining fluid conveyed by the pump is conducted to the at least one fluid consumer, and a flow measuring device, which is assigned to the inflow and comprises at least one first measuring unit and one second measuring unit, which are each configured to detect a throughflow rate of the machining fluid in the inflow. The control device is at least configured to control the hydraulic device as a function of a first actual value, which is detected by the first measuring unit, and/or a second actual value, which is detected by the second measuring unit, of the throughflow rate of the machining fluid, in particular by setting an operating parameter of the pump determining a delivery capacity.

In this way, a possibility is provided of retrofitting existing machine tools with a hydraulic device together with its own control device.

In contrast to the provision of the hydraulic device according to the second aspect, an independent hydraulic system with its own control device is thus provided, for the case where an existing control device of the machine tool is intended or can be used, for example, for controlling the hydraulic device (e.g. on account of incompatibilities in the data exchange or the like).

The hydraulic device of the hydraulic system can be designed according to each of the hydraulic devices described in the above-described embodiments of the machine tool, with the result that a new description is dispensed with at this point.

In this case, the control device of the hydraulic system can have the same functionalities as the above-described control device of the machine tool in relation to the hydraulic device of the machine tool.

The control device of the hydraulic system preferably corresponds to a control device of a machine tool, with the result that the hydraulic system according to the third aspect basically corresponds to a combination of the hydraulic device and the control device of the machine tool according to the first aspect of the invention.

As an alternative to the above embodiment, however, the control device of the hydraulic system can also be provided separately and, in particular, be coupled to a control device of a machine tool for data and signal transmission, with the result that the control devices can access the data of the respective other for the purpose of control.

The hydraulic system preferably comprises a setpoint value transmitter, via which a setpoint value of a throughflow rate present at the at least one fluid consumer or of a volumetric flow rate of the machining fluid is provided. This setpoint value transmitter is preferably designed as part of the control device of the hydraulic system.

In this case, the control device of the hydraulic system is preferably configured to control the hydraulic device as a function of the setpoint value provided by the setpoint value transmitter and the detected first actual value and/or the detected second actual value, in particular in order to control the throughflow rate present at the at least one fluid consumer.

The control device of the hydraulic system is preferably configured to set an operating parameter of the pump of the hydraulic device determining the delivery capacity, in particular a delivery quantity or a rotational speed of the pump, as a function of the provided setpoint value and the detected first actual value and/or the detected second actual value.

If the hydraulic device comprises a bypass device, the control device of the hydraulic system is preferably configured to control the bypass device, in particular to set one of the operating parameters of a throughflow regulating means of the bypass device determining the return flow through the bypass device.

According to a fourth aspect of the invention, a method for workpiece machining by means of a machine tool is provided, in particular by means of a machine tool according to the first aspect or a preferred embodiment in this respect. The method comprises at least supplying the machining fluid into a working space of the machine tool via at least one fluid consumer of the machine tool, in turn comprising operating a pump for conveying the machining fluid via an inflow to the at least one fluid consumer, detecting a first actual value of the throughflow rate, in particular the volume flow of the machining fluid at a first point of the inflow, detecting a second actual value of the throughflow rate, in particular the volume flow of the machining fluid at a second point of the inflow and controlling the machine tool for workpiece machining as a function of the detected first actual value and/or the detected second actual value, wherein the preceding steps are each carried out at least before and/or during machining of a workpiece placed in the working space by a tool of the machine tool.

As a result, a method for workpiece machining is provided which is likewise distinguished by the advantages already described above in the course of the machine tool according to the invention in the machining of workpieces which are not reproduced again at this point. The same applies to the preferred embodiments of the method described below which correspond to the respective preferred embodiments of the machine tool.

In this case, the machine tool can be configured to drive the tool and/or the workpiece in the course of the machining.

The first point and the second point of the inflow preferably lie in series with respect to a flow direction of the machining fluid.

The first actual value is preferably detected with a first measuring unit and the second actual value is preferably detected with a second measuring unit, the respective measuring ranges of which differ from one another. The statements made with respect to the measuring ranges and measurement deviations with respect to the machine tool likewise apply here.

The pump is preferably operated in a volumetric flow rate operating range of the pump which is preferably a range of 1 to 50 l/min, and preferably of 5 to 40 l/min.

In a preferred embodiment, the method comprises providing a setpoint value for a throughflow rate of the machining fluid present at the at least one fluid consumer during workpiece machining, wherein the control of the machine tool is carried out additionally as a function of the provided setpoint value.

The method preferably furthermore comprises selecting one of the two detected actual values as reference value, wherein the control of the machine tool is carried out as a function of the selected reference value.

Alternatively, the method can comprise determining a resulting throughflow rate value on the basis of the detected first and the detected second actual value. The determination is preferably carried out here by weighted averaging of the two detected actual values, wherein weighting factors with which the actual values are weighted during the averaging are themselves preferably dependent on one or both detected actual values.

The fluid consumer is preferably a tool interface for receiving a tool having an inner fluid duct, as described above.

In this case, the provision of the setpoint value preferably comprises setting the setpoint value as a function of the tool received therein, in particular as a function of a tool parameter. For this purpose, the provision of the setpoint value preferably comprises reading a tool parameter from a tool database, in particular a nominal setpoint throughflow rate or a setpoint volumetric flow rate of the received tool.

In this case, the reading of the tool parameter preferably comprises reading from a pump characteristic curve, stored in the tool database, of the received tool.

The provision of the setpoint value preferably comprises additionally or alternatively defining setting of the setpoint value as a function of at least one machining parameter of the workpiece machining. For this purpose, the provision of the setpoint value preferably comprises reading one or more machining parameters of the workpiece machining from a control device of the machine tool, in particular a cutting speed of the tool, a feed speed of the tool or a penetration depth of the tool into the workpiece to be machined.

The control of the machine tool preferably furthermore comprises adapting setting of at least one machining parameter of the workpiece machining at a control device of the machine tool as a function of the detected first and/or the detected second actual value. The at least one machining parameter to be set is preferably a machining speed of the tool and/or of the workpiece to be machined, in particular a cutting speed of the tool relative to the workpiece or a feed speed of the tool relative to the workpiece or a cutting force or contact force between tool and workpiece.

In a preferred embodiment, the control of the machine tool furthermore comprises controlling the throughflow rate present at the at least one fluid consumer, in particular the volumetric flow rate of the machining fluid, as a function of the provided setpoint value and the detected first actual value and/or the detected second actual value, preferably in turn comprising setting an operating parameter of the pump determining the delivery capacity as a function of the provided setpoint value and the detected first actual value and/or the detected second actual value.

Further aspects and the advantages thereof and also more specific exemplary embodiments of the abovementioned aspects and embodiments are described below with the aid of the drawings shown in the appended figures.

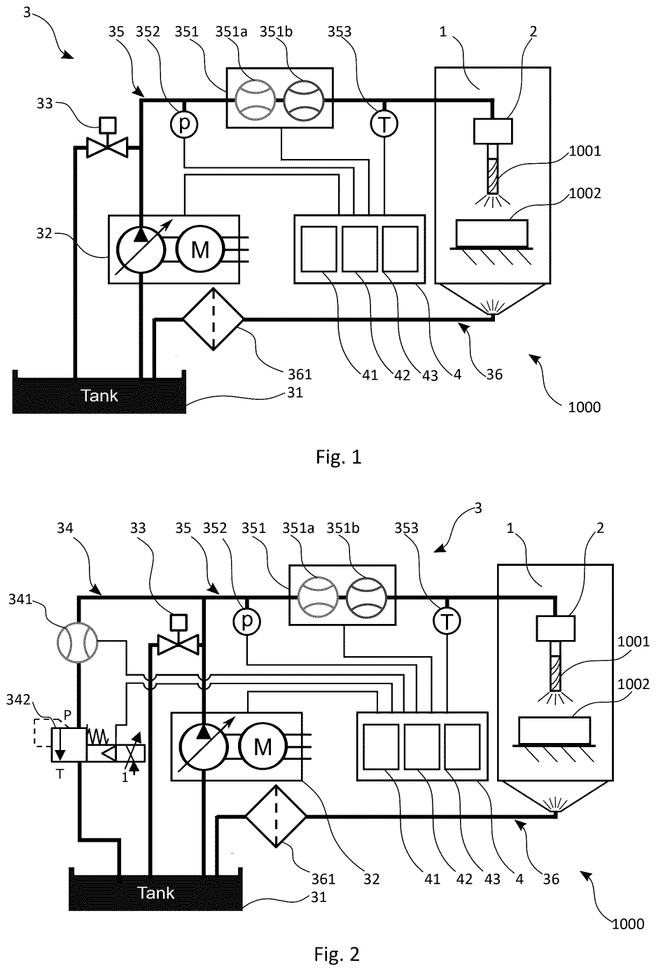

FIG. 1 shows a schematic view of a first exemplary embodiment of the machine tool according to the invention.

FIG. 2 shows a schematic view of a second exemplary embodiment of the machine tool according to the invention.

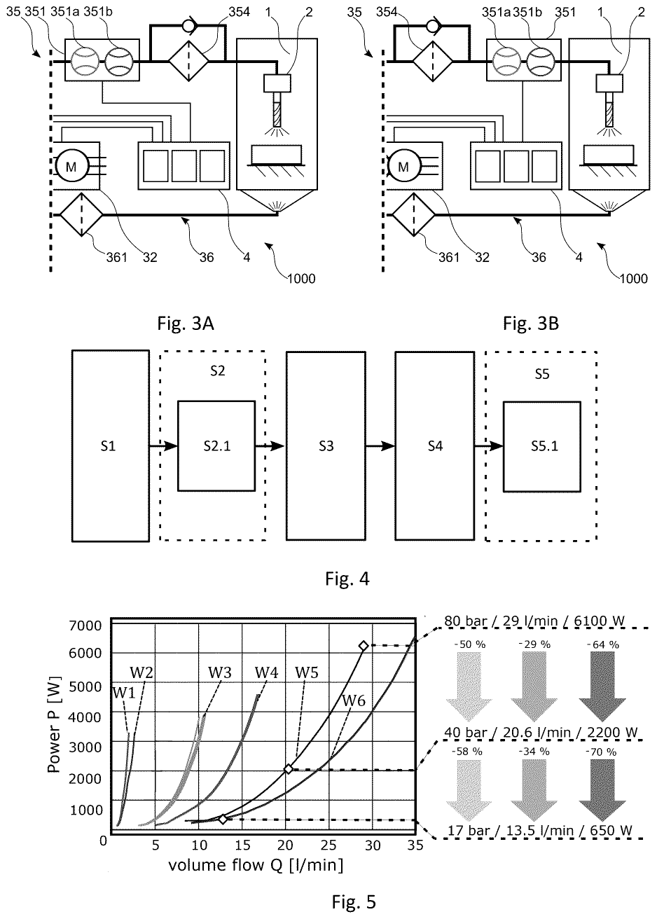

FIG. 3 shows a schematic view of a third exemplary embodiment of the machine tool according to the invention in two alternatives according to FIG. 3A and FIG. 3B.

FIG. 4 shows a schematic flow diagram of an exemplary embodiment of the method according to the invention for machining a workpiece.

FIG. 5 shows pump characteristic curves and operating points for different tools for use in the machine tool according to the invention with internal CL supply.

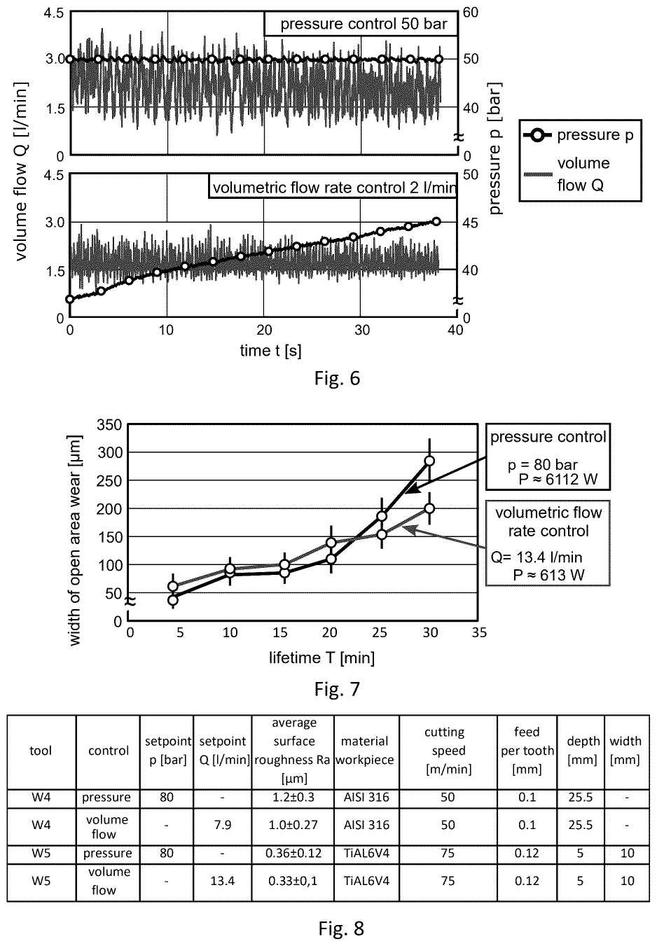

FIG. 6 shows measurement results of hydraulic variables during use of the invention during workpiece machining using an internal CL supply by the hydraulic device.

FIG. 7 shows measurement results for tool wear during use of the invention for workpiece machining using an internal CL supply by the hydraulic device.

FIG. 8 shows a table with machining results during use of the invention during workpiece machining using an internal CL supply by the hydraulic device.

It is emphasized that the present invention is in no way limited to the exemplary embodiments described below and the embodiment features thereof. The invention furthermore comprises modifications of the exemplary embodiments mentioned, in particular those which emerge from modifications and/or combinations of individual or a plurality of features of the exemplary embodiments described within the scope of protection of the independent claims.

### DETAILED DESCRIPTION OF THE FIGURES

FIG. 1 shows a schematic view of a first exemplary embodiment of the machine tool 1000 according to the invention.

The machine tool 1000 comprises a working space 1, in which the machining of a workpiece 1002 is carried out, a working spindle 2 as a fluid consumer, in which a tool 1001 can be received and rotationally driven, a hydraulic device 3, which is configured to supply the working spindle 2 with a cooling lubricant (CL), and a control device 4, which is configured to control the machine tool 1000.

CL for workpiece machining can be supplied to the working space 1 via the fluid consumer designed as a working spindle 2. In this case, the working spindle 2 corresponds to a tool interface, via which a tool 1001 received therein having at least one inner fluid duct can be supplied with CL in such a way that said tool is supplied to the working space 1 via the at least one fluid duct of the tool 1001 and thus implements the concept of internal CL supply.

In this case, the supply of the working spindle 2 with CL for the internal CL supply is carried out via the hydraulic device 3, which comprises a tank 11, in which the CL is provided, a pump 32 for conveying the CL and an inflow 35, via which CL is conducted from the pump 32 to the working spindle 2. In this case, a pressure relief valve 33 protects the hydraulic device 3 from damage if the pump 32 were to convey and a volumetric flow rate through the inflow 35 would be blocked.

The CL supplied to the machine tool 1000 is collected and returned to the tank 31 through an outflow 36 of the hydraulic device, which comprises an outflow filter 361.

The hydraulic device can furthermore comprise a pressure sensor 352 and/or a temperature sensor 353 at the inflow 35, as shown in FIG. 1, as a result of which a comprehensive description of the state of the CL in the inflow 35 is made possible by way of and for use in the controller.

Furthermore, the hydraulic device 3 comprises a volume flow measuring device 351, which is assigned to the inflow and comprises a first volume flow sensor 351a and a second volume flow sensor 351b, which are arranged in series with respect to the flow direction of the CL in the inflow 35 and are each configured to detect a volume flow rate of the CL in the inflow 35.

The two volume flow sensors 351a and 351b preferably have different measuring ranges, which are each not subsets of one another, such that the measuring ranges complement one another in order to make it possible to reliably detect a volumetric flow rate in the inflow 35 with as small a measurement deviation as possible at least over the complete volumetric flow rate operating range of the pump 32. Preferred values of the measuring ranges can be gathered from the above summary.

The control device 4 is coupled to the hydraulic device 3 and in this case coupled at least to the two volume flow sensors 351a, 351b.

Furthermore, in the present exemplary embodiment, the control device 4 is configured to control the hydraulic device 3 or to control a CL volumetric flow rate present at the working spindle 2 during the machining of the workpiece 1002. For this purpose, the control device 4 comprises a setpoint value transmitter 41, via which a setpoint value of the CL volumetric flow rate present at the working spindle 2 is provided.

The control device 4 can optionally or additionally also be connected to other actuators of the machine tool, for example to a drive of the working spindle 2.

The setpoint value can be set manually by a machine operator at the setpoint value transmitter 41. Alternatively or additionally, the setpoint value transmitter 41 can be configured to access a tool parameter, stored in a memory device 43 of the control device, of the tool 1001 and to determine the setpoint value on the basis thereof. Alternatively or additionally, the setpoint value transmitter 41 can be configured to access a tool database via a data interface 42 of the control device 4 and to read a tool parameter of the tool 1001 there and to determine the setpoint value on the basis thereof. Alternatively or additionally, the setpoint value can be transmitted to the setpoint value transmitter 41 via the data interface 42.

For the purpose of implementing a volumetric flow control, the control device 4 is coupled to the pump 32 of the hydraulic device 3 and is configured to control an operating parameter of the pump 32 determining the delivery capacity, in particular a rotational speed, as a function of the setpoint value provided by the setpoint value transmitter 41, a first actual value detected by the first volume flow sensor 351a and/or a second actual value, detected by the second volume flow sensor 351b, of the volumetric flow rate of the CL in the inflow 35.

The described construction of the machine tool 1000 or of the hydraulic device 3 therefore permits a reliable volumetric flow controller during the supply of the working spindle 2 with CL during the machining, to be precise independently of the fluid-mechanical properties of a tool 1001 received therein. As a result of this volumetric flow control made possible for a multiplicity of tools, the disadvantageous operating states with an “excessively high” pressure which occur in the prior art during the pressure control can be successfully avoided. As a result, a loading of the hydraulic device 3 and a power loss occurring within the latter can be considerably reduced, which in turn reduces the energy costs during the operation of the machine tool 1000 and increases the service life of the hydraulic device 3 itself.

A combination of hydraulic device 3 and control device 4 of the machine tool 1000 in FIG. 1 furthermore corresponds to an exemplary embodiment of the hydraulic system according to the invention, since the control device 4 of the machine tool 1000 there is configured at least to control the hydraulic device 3.

As an alternative to the construction shown in FIG. 1, a separate control device for the hydraulic device can also be provided (not illustrated), which control device for its part can in turn be coupled to a control device of the machine tool, wherein the latter is configured to control other actuators of the machine tool.

FIG. 2 shows a schematic view of a second exemplary embodiment of the machine tool 1000 according to the invention.

The second exemplary embodiment corresponds for the most part to the first exemplary embodiment and differs from the latter by a bypass 34, which is arranged between inflow 35 and pump 32 and via which at least one subset of the CL conveyed by the pump 32 can be conducted to the tank 31 as a backflow. As a result, volumetric flow rates which lie below a minimum volumetric flow rate of the pump 32 can also be provided in the inflow 35.

In the present case, the bypass 34 comprises a throughflow regulating means which is designed as a controllable throttle valve 342 and via which a throughflow through the bypass can be regulated, for example by setting a degree of opening of the throttle valve for adapting a flow resistance in the bypass 34.

Furthermore, the bypass comprises its own, third volume flow sensor 341, which is configured to detect the volumetric flow rate of the return flow in the bypass 34.

In this case, the volumetric flow rate provided by the pump 32 results from the sum of the volumetric flow rates in the inflow 35 and in the bypass 34 which can be detected via the respective sensors 341, 351a, 351b.

The control device is preferably configured to control an operating parameter of the throughflow regulating means determining the return flow as a function of the detected first and/or the detected second actual value, or as a function of the determined resulting volumetric flow rate, and/or the provided setpoint value, in particular in order to control the volumetric flow rate present at the at least one fluid consumer.

Both the throttle valve 342 and the third volume flow sensor 341 are coupled to the control device 4. For the purpose of the volumetric flow control in the inflow 35, said control device is in this case configured to control the hydraulic device 3 as a function of a detected first actual value of the first volume flow sensor 351a and/or a detected second actual value of the second volume flow sensor 351b and/or a detected third actual value of the third volume flow sensor 341 and the provided setpoint value of the setpoint value transmitter 41.

For this purpose, the control device 4 is configured to set an operating parameter of the pump 32 determining the delivery capacity and/or an operating parameter of the throttle valve 342 in the bypass 34 determining the return flow as a function described above, in particular in order to control the volumetric flow rate present at the working spindle 2 during the workpiece machining.

FIG. 3 shows a schematic view of a third exemplary embodiment of the machine tool 1000 according to the invention in two alternatives according to FIG. 3A and FIG. 3B.

The two alternatives of the third exemplary embodiment correspond for the most part to the second exemplary embodiment. For reasons of the simplified illustration, a new reproduction of the left-hand section identical to FIG. 2 has been dispensed with in FIGS. 3A and 3B.

The alternatives of the third exemplary embodiment differ from the second exemplary embodiment by the use of an inflow filter 354 in the inflow 35, which inflow filter is arranged downstream of the volume flow measuring device 351 in the flow direction in FIG. 3A and upstream of the volume flow measuring device 351 in the flow direction in FIG. 3B. Furthermore, the machine tool 1000 is not equipped with the optional pressure and temperature sensors in the inflow 35. The inflow filter 354 can optionally comprise the check valve illustrated in FIG. 3A and FIG. 3B.

Via the inflow filter 354, contamination in the CL can be removed upstream of the supply, which contamination could, for example, have a negative effect on the machining or under certain circumstances could even block the fluid ducts of the tool 1001.

In this case, the inventors have found out that, in particular, the arrangement of the volume flow measuring device 351 downstream of the inflow filter 354 according to FIG. 3B achieves the best results in the volume flow control on the working spindle 2 since, inter alia, no further components, such as said inflow filter 354, which could have an effect on the already measured CL flow, are arranged between the measuring point and the control point on the fluid consumer or the working spindle 2. This is advantageous in particular if the inflow filter 354, as shown in FIG. 3A and FIG. 3B, is designed with a check valve, via which part of the already measured CL flow is branched off under certain circumstances before being supplied to the working spindle 2.

Furthermore, the inflow filter 354 can also be arranged between the pump and the branch into the bypass 34 shown in FIG. 2, as a result of which measurement results of the return flow in the bypass 34 are furthermore improved.

Said inflow filter 354 can of course also be used analogously in the exemplary embodiment without the bypass 34 from FIG. 1 in the statements according to FIG. 3A and FIG. 3B.

FIG. 4 shows a schematic flow diagram of an exemplary embodiment of the method according to the invention for machining a workpiece on a machine tool using a machining fluid, in particular a CL.

In step S1, a setpoint value for a throughflow rate present at a fluid consumer during workpiece machining, for example a volumetric flow rate, of the machining fluid is provided.

In step S2, the machining fluid is supplied into a working space of the machine tool via the fluid consumer, comprising the substep S2.1 of operating a pump for conveying the machining fluid via an inflow to the fluid consumer.

In step S3, a first actual value of the throughflow rate of the machining fluid at a first point of the inflow is detected.

In step S4, a second actual value of the throughflow rate of the machining fluid at a second point of the inflow is detected.

In step S5, the machine tool for workpiece machining is controlled as a function of the provided setpoint value from step S1, the detected first actual value from step S3 and/or the detected second actual value from step S4, comprising the substep S5.1 of setting an operating parameter of the pump determining a delivery capacity, in particular the rotational speed, as a function of the provided setpoint value and the detected first actual value and/or the detected second actual value.

All of the preceding steps are each carried out at least before and/or during machining of a workpiece placed in the working space by a tool received by the machine tool.

FIG. 5 shows exemplary pump characteristic curves and operating points for different tools W1 to W6 for use in the machine tool according to the invention with internal CL supply.

Here, the pump characteristic curves correspond to tool-specific power curves of a pump of a hydraulic device designed for the internal CL supply as a function of the volume flow of the CL provided by the pump without using a bypass.

Data of the associated tools W1 to W6 can be gathered from the following table.

| | | tool diameter | number of | diameter of fluid |
|---|---|---|---|---|
| tool | tool type | [mm] | fluid ducts | ducts [mm] |
| W1 | drill | 3 | 2 | 0.25 |
| W2 | drill | 6 | 2 | 0.60 |
| W3 | thread cutter | M10 × 1.5 | 1 | 2.00 |
| W4 | drill | 8.5 | 2 | 0.80 |
| W5 | milling cutter | 32 | 3 | 2.00 |
| W6 | milling cutter | 63 | 25 | 1.20 |

The power curves all show a substantially exponential dependence of the power on the converted volume flow. A slight change in the volume flow rate therefore leads to a significant change in the power and therefore also to a significant change in the energy costs arising during operation.

By way of example, in the case of the pump characteristic curve for W5, the prevailing pressures are additionally specified at excellent points. Thus, at a volume flow rate of 29 l/min, a pressure of 80 bar prevails, at a volume flow rate of 20.6 l/min, a pressure of 40 bar prevails and at a volume flow rate of 13.5 l/min, a pressure of 17 bar prevails. Proceeding from the uppermost data point, it is found that halving the pressure merely leads to a decrease of approximately 29% of the volume flow rate, but already to a decrease of approximately 64% of the power. In this case, a volume flow rate of 20.6 l/min for the tool W5 is already more than sufficient for the workpiece machining, which in addition leads to a significantly lower pressure and therefore to a significantly lower loading of the hydraulic device.

The pump characteristic curves of the tools W1 to W6 clarify the problem of pure pressure control, in the case of which, on suspicion, a high pressure is set at the pump, in order to avoid the risk of CL undersupply. Thus, this strategy usually leads to unnecessary energy costs and overloading of the hydraulic device, although operation with a significantly lower pressure and therefore a lower power of the pump already leads to sufficient CL supply for a specific tool.

The departure from the pressure control known in the prior art to a volume flow control is made possible in this case by the present invention.

Said pump characteristic curves can be provided to the control device of the machine tool, for example in a memory device and/or via an interface in an external tool management database.

FIG. 6 shows measurement results of hydraulic variables during use of the invention during workpiece machining using an internal CL supply by the hydraulic device.

FIG. 6 shows a comparison of hydraulic variables of a conventional pressure control (upper diagram) and of the volume flow control according to the invention (lower diagram) during the introduction of a bore into a workpiece with a tool according to W2 (drill). Further parameters of the workpiece machining were:
Material of the workpiece: AISI 316 (austenitic chromium-nickel-molybdenum steel)
Cutting speed: 50 m/min
Feed per tooth: 0.1 mm
Depth of the bore: 180 mm

The penetration depth into the workpiece is in this case proportional to the time, since a constant feed was selected.

In both diagrams, time profiles of the pressure p present at the drill during workpiece machining and of the present volumetric flow rate Q of the CL are illustrated. In the case of the pressure control, a setpoint value of the pressure of 50 bar is predefined, whereas in the case of the volumetric flow rate control, a setpoint value of the volumetric flow rate of 2 l/min is predefined.

As can be gathered from the upper diagram, the pressure p can be kept approximately constant at 50 bar, wherein the volumetric flow rate Q resulting therefrom is subjected to strong fluctuations with a comparatively high frequency. Thus, this fluctuates by approximately 3.3 l/min about a mean value Q*≈2.1 l/min in a range from a minimum Qₘᵢₙ≈0.5 l/min to a maximum Qmax≈3.8 l/min. The volumetric flow rate Q at the drill converted by the pressure control is very volatile and has an effect on the machining quality at the workpiece, which therefore likewise fluctuates and leads to non-uniform machining results.

By contrast, an extremely stable volumetric flow rate Q with lower fluctuations is shown in the lower diagram. Thus, this fluctuates by approximately 2.0 l/min about a mean value Q*≈2.0 l/min in a range from a minimum Qₘᵢₙ≈1.0 l/min to a maximum Qₘₐₓ≈3.0 l/min. The pressure profile in this case shows that, in order to maintain the setpoint value of the volumetric flow rate Q of 2.0 l/min, the pressure p rises virtually linearly from approximately 35 bar to 45 bar as the penetration depth progresses.

Therefore, the volumetric flow rate control supplies a supply with CL with virtually the same mean value of the volumetric flow rate and lower fluctuations than in the case of the pressure control. At the same time, a consistently lower pressure prevails, which leads to lower energy costs and also to a lower loading of the hydraulic components and therefore to an increased service life in comparison with the pressure control.

The measurement results discussed above show the advantages of the volumetric flow rate control during workpiece machining, which can only be reliably implemented by the construction according to the invention of the machine tool or of the hydraulic device with two measurement units.

FIG. 7 shows measurement results for tool wear during use of the invention for workpiece machining using an internal CL supply by the hydraulic device.

The diagram in FIG. 7 shows a comparison of time profiles of the tool wear in a conventional pressure control and of the volumetric flow rate control according to the invention during milling of a free surface in each case with a tool according to W5 (milling cutter). Further parameters of the workpiece machining were:
Material of the workpiece: TiAl6V4
Cutting speed: 75 m/min
Feed per tooth: 0.12 mm
Width and depth of the removal: 10 mm and 5 mm

In the diagram, the tool wear over the service life of the milling cutter in minutes is illustrated, wherein the workpiece machining is carried out in one case with conventional pressure control with a setpoint value of the pressure p of 80 bar and in the other case with volumetric flow rate control according to the invention with a setpoint value of the volumetric flow rate Q of 13.4 l/min. The degree of tool wear takes place by specifying the width of the worn surface of the free surface of the tool in μm.

As can be gathered from the diagram, an approximately equal rise in the tool wear for the cases of pressure and volumetric flow rate control is shown at the beginning. In the further course, however, the tool wear in the case of pressure control experiences a significant rise and, towards the end, is clearly distinguished from the tool wear in the case of volumetric flow rate control.

The volumetric flow rate controller according to the invention therefore also has a positive effect on the tool wear, such that tools can be used longer and have to be replaced less often, which in turn leads to lower operating costs.

Furthermore, the average power values of the pump for supplying the tool with CL for the two cases, which differ approximately by a factor of 10, are also specified in the diagram, such that the volumetric flow rate controller according to the invention also leads to significant energy savings here in comparison with the conventional pressure control.

Furthermore, the inventors have found that the use of the volumetric flow rate controller also leads to better machining results in comparison with the conventional volumetric flow rate controller, as can be gathered from the table illustrated in FIG. 8.

The table in FIG. 8 shows a comparison of the average surface roughness Ra achieved on the workpiece after machining with a drill according to W4 and a milling cutter according to W5 with the respectively specified machining parameters, in each case using the conventional pressure control and the volumetric flow rate controller according to the invention.

In the case of volumetric flow rate control, lower surface roughnesses were achieved in this case for both tools with otherwise identical machining parameters, and therefore a better surface quality of the workpiece could also be achieved through the use of the volumetric flow rate controller.

The volumetric flow rate controller according to the invention therefore furthermore also affords advantages with regard to the machining quality.

Exemplary embodiments of the present invention and the advantages thereof have been described in detail above with reference to the appended figures.

It is emphasized again that the present invention is in no way limited to the exemplary embodiments described above and the embodiment features thereof.

The invention furthermore comprises modifications of the exemplary embodiments mentioned, in particular those which emerge from modifications and/or combinations of the features of the exemplary embodiments described within the scope of protection of the independent claims.

### LIST OF REFERENCE SIGNS

1 working space
2 working spindle as tool interface (fluid consumer)
3 hydraulic device
4 control device of the machine tool
31 tank
32 pump
33 pressure relief valve
34 bypass
35 inflow
36 outflow
341 third volume flow sensor (bypass)
342 controllable throttle valve
351 volume flow measuring device
351a, 351b first, second volume flow sensor (volume flow measuring device)
352 pressure sensor
353 temperature sensor
354 inflow filter
361 outflow filter
41 setpoint value transmitter
42 data interface
43 memory device
1000 machine tool
1001 tool
1002 workpiece

1. Machine tool (1000) for workpiece machining, comprising:
a working space (1);
at least one fluid consumer (2), via which a machining fluid for workpiece machining, in particular a cooling lubricant, can be supplied to the working space (1);
a hydraulic device (3), which is configured to supply the at least one fluid consumer (2) with the machining fluid, in turn comprising:
a pump (32) for conveying the machining fluid;
an inflow (35), via which machining fluid conveyed by the pump (32) is conducted to the at least one fluid consumer (2); and
a flow measuring device (351), which is assigned to the inflow (35) and comprises at least one first measuring unit and one second measuring unit, which are each configured to detect a flow rate of the machining fluid in the inflow (35);
and a control device (4) for controlling the machine tool (1000), which is configured to control the machine tool (1000), in particular the hydraulic device (3), as a function of a first actual value, which is detected by the first measuring unit (351a), and/or a second actual value, which is detected by the second measuring unit (351b), of the throughflow rate of the machining fluid in the inflow (35).

2. Machine tool (1000) according to claim 1, wherein
the flow measuring device is a volume flow measuring device (351), such that the flow rate in the inflow (35) is specified via a volume flow.

3. Machine tool (1000) according to claim 1 or 2, wherein
the first measuring unit (351a) and the second measuring unit (351b) are arranged in series with respect to a flow direction of the machining fluid in the inflow (35).

4. Machine tool (1000) according to at least one of the preceding claims, wherein
a measuring range of the first measuring unit (351a) differs from a measuring range of the second measuring unit (351b), in particular none of the two measuring ranges is a subset of the respectively other measuring range.

5. Machine tool (1000) at least according to claim 4, wherein
the measuring range of the first measuring unit (351a) and the measuring range of the second measuring unit (351b) overlap in an overlap region.

6. Machine tool (1000) at least according to claim 2 and claim 5, wherein
the measuring range of the first measuring unit (351a) is a range of 0 to 30 l/min, preferably a range of 0.01 to 15 l/min; and
the measuring range of the second measuring unit (351b) is a range of 1 to 80 l/min, preferably a range of 1 to 50 l/min.

7. Machine tool (1000) at least according to claim 2 and claim 5, wherein
the measuring ranges of the first and second measuring units (351a, 351b) and a minimum volumetric flow rate of the pump (32) are matched to one another in such a way that the minimum volumetric flow rate lies in the overlap region.

8. Machine tool (1000) at least according to claim 2 and one of claims 3 to 7, wherein
a volumetric flow rate operating range of the pump (32) is a subset of a combining set of the measuring ranges of the first and second measuring units (351a, 351b).

9. Machine tool (1000) at least according to claim 8, wherein
the volumetric flow rate operating range of the pump (32) is a range of 0.1 to 80 l/min, preferably of 5 to 40 l/min.

10. Machine tool (1000) at least according to one of the preceding claims, wherein
the machine tool (1000) furthermore comprises a setpoint value transmitter (41), via which a setpoint value of a throughflow rate of the machining fluid present at the at least one fluid consumer (2) is provided,
wherein the control device (4) is configured to control the hydraulic device (3) as a function of the provided setpoint value and the detected first actual value and/or the detected second actual value, in particular in order to control the throughflow rate present at the at least one fluid consumer (2).

11. Machine tool (1000) at least according to claim 10, wherein
the control device (4) is configured to set an operating parameter of the pump (32) of the hydraulic device (3) determining the delivery capacity, in particular a delivery quantity or a rotational speed of the pump (32), as a function of the provided setpoint value and the detected first actual value and/or the detected second actual value.

12. Machine tool (1000) at least according to one of the preceding claims, wherein
the hydraulic device (3) furthermore comprises a bypass device (34) arranged between the inflow (35) and the pump (32).

13. Machine tool (1000) at least according to claim 12, wherein
the bypass device (34) comprises at least one throughflow regulating means (342), via which a throughflow of a return flow of the machining fluid flowing through the bypass device (34) can be regulated, in particular a controllable bypass valve (342) or a controllable bypass pump.

14. Machine tool (1000) at least according to claim 10 and claim 13, wherein
the bypass device (34) comprises a third measuring unit (341), which is configured to detect a throughflow rate of the return flow of the machining fluid flowing through the bypass device (34), and
wherein the control device (4) is configured to control the hydraulic device (3) additionally as a function of an actual value, which is detected by the third measuring unit (341), of the throughflow rate of the return flow.

15. Machine tool (1000) at least according to one of the preceding claims, wherein
the at least one fluid consumer is a tool interface (2) for receiving a tool (1001) having at least one inner fluid duct, wherein the tool interface (2) is configured to supply the machining fluid conducted thereto to the working space (1) via the at least one fluid duct of the tool (1001) received in the tool interface (2).

16. Machine tool (1000) at least according to claim 15, wherein
the tool interface is designed as a working spindle (2) for receiving and rotationally driving a tool (1001).

17. Machine tool (1000) at least according to either of claims 15 and 16, wherein
the setpoint value transmitter (41) is configured to define the setpoint value as a function of a tool parameter of a tool (1001) received in the tool interface (2) and/or as a function of at least one machining parameter, which is present at the control device (4), of the workpiece machining, which machining parameter is in particular a cutting speed of the tool (1001), a feed speed of the tool (1001) or a penetration depth of the tool (1001) into the workpiece (1002) to be machined.

18. Machine tool (1000) at least according to one of the preceding claims, wherein
the control device (4) is furthermore designed for process monitoring of workpiece machining in the working space (1) and in this context is configured to adapt at least one machining parameter of the workpiece machining as a function of the detected first and/or the detected second actual value, in particular a machining speed of the tool (1001) and/or of the workpiece (1002) to be machined.

19. Machine tool (1000) according to claim 18, wherein
the control device (4) is furthermore configured to instruct a machine stop of the machine tool (1000) if the detected first actual value lies outside a predetermined first setpoint range and/or the detected second actual value lies outside a second predetermined setpoint range.

20. Hydraulic device (3) of a machine tool (1000) according to one of claims 1 to 19.

21. Hydraulic system for use on a machine tool (1000), comprising:
a hydraulic device (3), which is configured to supply at least one fluid consumer (2) of the machine tool (1000) with a machining fluid for workpiece machining, in turn comprising:
a pump (32) for conveying the machining fluid;
an inflow (35), via which machining fluid conveyed by the pump (32) is conducted to the at least one fluid consumer (2); and
a flow measuring device (351), which is assigned to the inflow (35) and comprises at least one first measuring unit (351a) and one second measuring unit (351b), which are each configured to detect a throughflow rate of the machining fluid in the inflow (35);
and a control device (4), which is at least configured to control the hydraulic device (3) as a function of a first actual value, which is detected by the first measuring unit (351a), and/or a second actual value, which is detected by the second measuring unit (351b), of the throughflow rate of the machining fluid, in particular by setting an operating parameter of the pump (32) determining a delivery capacity.

22. Method for machining a workpiece by means of a machine tool (1000), in particular by means of a machine tool according to at least one of claims 1 to 19, comprising the steps:
supplying the machining fluid into a working space (1) of the machine tool (1000) via at least one fluid consumer (2), in turn comprising:
operating a pump (32) for conveying the machining fluid via an inflow (35) to the at least one fluid consumer (2);
detecting a first actual value of the throughflow rate of the machining fluid at a first point of the inflow (35);
detecting a second actual value of the throughflow rate of the machining fluid at a second point of the inflow (35); and
controlling the machine tool (1000) for workpiece machining as a function of the detected first actual value and/or the detected second actual value;
wherein the preceding steps are each carried out at least before and/or during machining of a workpiece (1002) placed in the working space (1) by a tool (1001) received by the machine tool (1000).

23. Method according to claim 22, further comprising the step:
providing a setpoint value for a throughflow rate of the machining fluid present at the at least one fluid consumer (2) during workpiece machining;
wherein the control of the machine tool (1000) is carried out additionally as a function of the provided setpoint value.

24. Method according to claim 23, wherein
the control of the machine tool (1000) further comprises:
setting an operating parameter of the pump (32) determining a delivery capacity as a function of the provided setpoint value and the detected first actual value and/or the detected second actual value.
